(19) United States
(12) Patent Application Publication
(10) Pub. No.: US 2021/0300626 A1
(43) Pub. Date: Sep. 30, 2021

(54) COMPACT INGREDIENT CONTAINER

(71) Applicant: Ronda Shamansky, Columbus, OH (US)

(72) Inventor: Ronda Shamansky, Columbus, OH (US)

(21) Appl. No.: 17/167,022

(22) Filed: Feb. 3, 2021

Related U.S. Application Data
(60) Provisional application No. 62/969,617, filed on Feb. 3, 2020.

(51) Int. Cl. B65D 25/04; B65D 43/16; B65D 43/22; B65D 85/00

(52) U.S. Cl. CPC B65D 25/04; B65D 43/162; G01F 19/002; B65D 85/70; B65D 43/22

(57) ABSTRACT

The current application is directed towards a compact ingredient container for separately storing small quantities of baking ingredients and allowing for easy dispensing thereof. In a version, the compact container generally comprises a compartment body comprising a plurality of separate compartments, each separate compartment providing a depth and a volume of space, and terminating at an upper perimeter defining a top opening. The compact container may provide one or more lids configured to operably connect and close over each of the respective top openings of the plurality of compartments, thereby forming a sealed volume of space within each compartment for each independent baking ingredient contained therein.

### CROSS-REFERENCE TO RELATED APPLICATION

This application is based upon and claims the priority filing date of the previously filed, copending U.S. provisional patent application entitled “COMPACT INGREDIENT CONTAINER” filed Feb. 3, 2020, having App. No. 62/969,617, the entire disclosure of which is hereby incorporated herein by reference.

### FIELD OF THE INVENTION

The present invention relates to the field of food containers, particularly with regard to a food container for storing, measuring, and dispensing small quantities of baking ingredients.

### BACKGROUND

Nearly all baking recipes call for a very small amount of three different dry ingredients necessary for leavening, texture, and flavor: baking powder, baking soda, and salt. Even though only a miniscule amount of each ingredient is used in most recipes, a home cook or baker must purchase and store large packages of each ingredient at home. The large packages take up precious storage space in a kitchen, and, because only a small amount of each is used in most recipes, the ingredients are often stale by the time the last amounts in those packages are used, thereby diminishing the quality of the pastry or other baked goods.

### SUMMARY

The current application is directed towards a compact ingredient container for separately storing small quantities of baking ingredients and allowing for easy dispensing thereof. Preferably, the compact container comprises at least three compartment for storing baking powder, baking soda, and salt. In accordance with a version of the invention, the compact container generally comprises a compartment body comprising a plurality of separate compartments, each separate compartment providing a depth and a volume of space, and terminating at an upper perimeter defining a top opening; one or more lids configured to operably connect and close over each of the respective top openings of the plurality of compartments, thereby forming a sealed volume of space within each compartment for each independent baking ingredient contained therein; and one or more leveling shelves having a forward leveling edge, each leveling shelf is operably positioned atop and extending laterally across each of the respective compartment top openings, thereby allowing a user to dispense and level off a measuring spoon containing a portion of the selected baking ingredient.

In certain embodiments of the application, the compact ingredient container may further include a measuring spoon for dispensing quantities of the baking ingredients, the container further comprising a slot configured and shaped to receive and store the measuring spoon while not in use.

In a certain version of the application, the one or more lids are integrally attached forming a unitary lid portion, the lid portion is hingedly connected to the compartment body portion permitting the container to move uniformly between a closed position and an open position.

In certain versions, each of the upper perimeters of the compartments form an elevated lip.

In yet other versions of the application, each of the one or more lids is formed as a cap imprint within the unitary lid portion, each cap imprint is operably dimensioned to fit over and mate with the respective elevated lip of each separate compartment.

In a version of the application, the one or more leveling shelves are integrally attached forming a unitary leveling shelf portion, the leveling shelf portion operably seats atop the compartment body.

In a detailed version, each of the one or more leveling shelves comprise one or more inwardly projecting tabs and wherein each of the compartment elevated lips comprise one or more reciprocal indents, wherein while the one or more leveling shelves are fitted over the respective elevated lips, the respective tabs mate with the respective indents, thereby providing a friction type fit between the leveling shelf and the respective compartment top opening.

In another version, each of the cap imprints comprise one or more inwardly projecting tabs and wherein each of the compartment upper lips comprise one or more respective indents, wherein while in the closed position, the tabs mate with the respective indents, thereby providing a friction type fit between the lid portion and the compartment body.

Preferably, the container further includes a measuring spoon for dispensing quantities of the baking ingredients, the container further comprising a slot configured and shaped to receive and store the measuring spoon while not in use.

These and other features of the present invention will become clear upon further review of the following specification and drawings.

### BRIEF DESCRIPTION OF THE DRAWINGS

These and other features, aspects, and advantages of the present invention will become better understood with regard to the following description and accompanying figures where:

FIG. 1 is a front illustrative view of each of the three primary ingredients that a baker requires and stores for everyday use, namely, baking powder, baking soda, and salt;

FIG. 2 is a front perspective view of a first version of the compact ingredient container shown while in the open position;

FIG. 3 is front perspective view of the version shown in FIG. 2 while in the open position and filled with the baking ingredients shown in FIG. 1, namely, baking powder, baking soda, and salt;

FIG. 4 is a top down plan view of the version shown in FIG. 2 shown while in the closed position;

FIG. 5 is a bottom view of the version shown in FIG. 2:

FIG. 6 is an up-close view of the spoon seating of the version shown in FIG. 2;

FIG. 7 is a bottom view of the hinged lid portion of the version shown in FIG. 2 shown while in the open position;

FIG. 8 is a top view of the ingredient container portion of the version show in FIG. 2;

FIG. 9 is a top plan view of the ingredient container portion shown without the removable shelf portion of the version shown in FIG. 2;

FIG. 10 is a left-side perspective view of the ingredient container portion of the version shown in FIG. 2;

FIG. 11 is a left-side bottom perspective view of the hinged lid portion of the version shown in FIG. 2; and

FIG. 12 is a second version of the compact ingredient container shown while in the open position.

### DETAILED DESCRIPTION

In the following description, for purposes of explanation and not limitation, specific details are set forth such as particular architectures, interfaces, techniques, etc. in order to provide a thorough understanding of the present invention. However, it will be apparent to those skilled in the art that the present invention may be practiced in other versions that depart from these specific details. In other instances, detailed descriptions of well-known devices, circuits, and methods are omitted so as not to obscure the description of the present invention with unnecessary detail.

Moreover, the description is not to be taken in the limiting sense, but is made merely for the purpose of illustrating the general principles of the invention, since the scope of the invention is best defined by the appended claims. Various inventive features are described below that can each be used independently of one another or in combination with other features.

Unless otherwise defined, all technical terms used herein have the same meaning as commonly understood by one of ordinary skill in the art to which the invention belongs. As used in the specification and the appended claims, the singular forms “a,” “an,” and “the” include plural references unless the context clearly dictates otherwise. Any reference to “or” herein is intended to encompass “and/or” unless otherwise stated.

Generally speaking, the compact ingredient container is operably configured to separately store and package small quantities of baking ingredients, such as baking powder, baking soda, and/or salt, in one compact container. The container allows a cook or baker to purchase and store at least three essential baking ingredients in reasonably small quantities, given that so little of each is typically used in home baking recipes, and allows the baker to easily measure each ingredient as it is dispensed from the container. For example, the container permits the quantities of baking ingredients to be easily dispensed and measured by a measuring spoon and one or more horizontal leveling shelves. Further, the container saves cupboard space and, because it holds only a small amount of each substance, allows the ingredients to be used before they lose their freshness or efficacy.

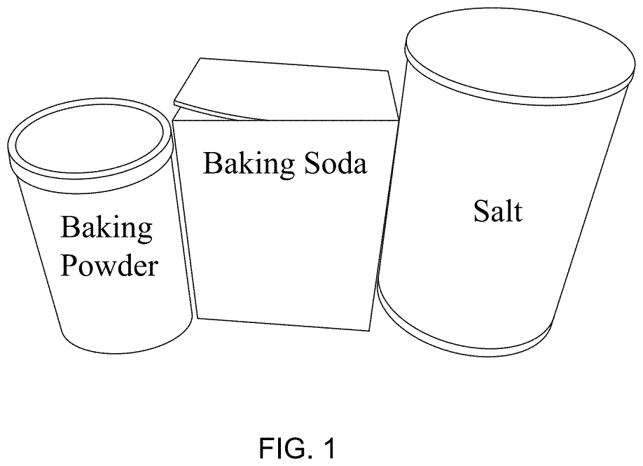

FIG. 1 shows typical containers for each of the three main ingredients that a baker must currently buy and store, namely, baking powder, baking soda, and salt. Generally, the compact ingredient container is intended to replace these individual products with a compact and easy-to-use container for all three baking ingredients—providing separate compartments for each and when the container is completely closed, the separate lids of the three compartments prevent the baking ingredients from mixing together.

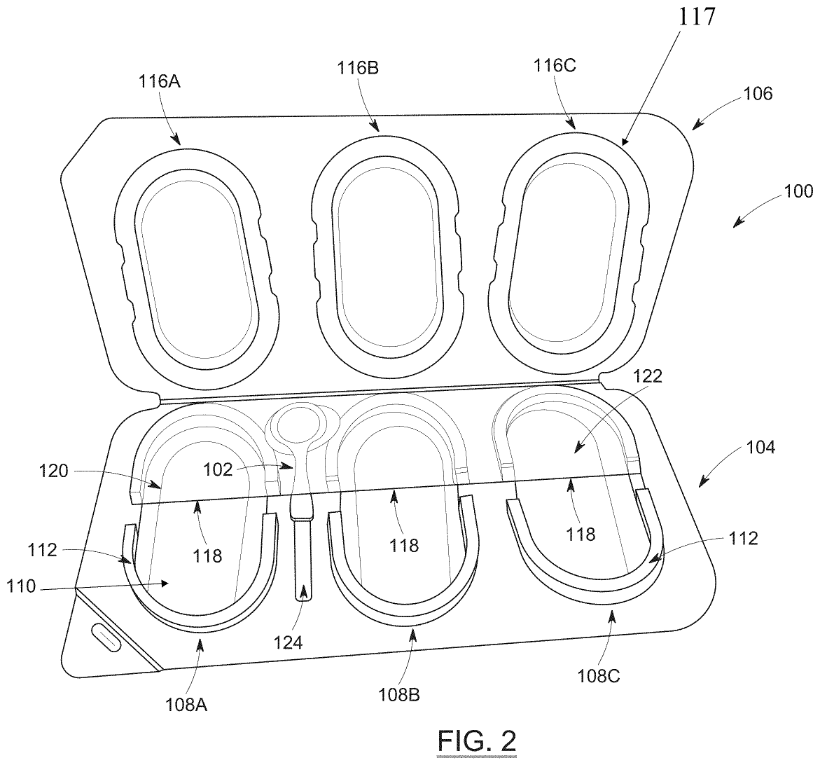

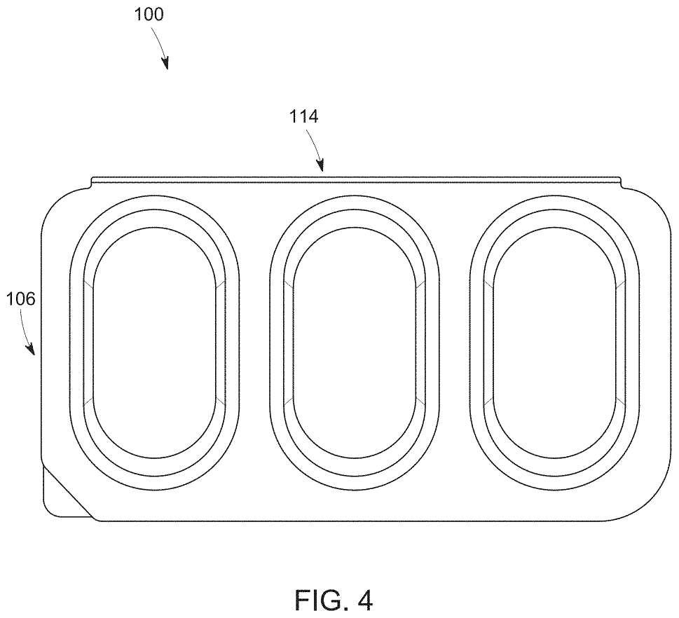

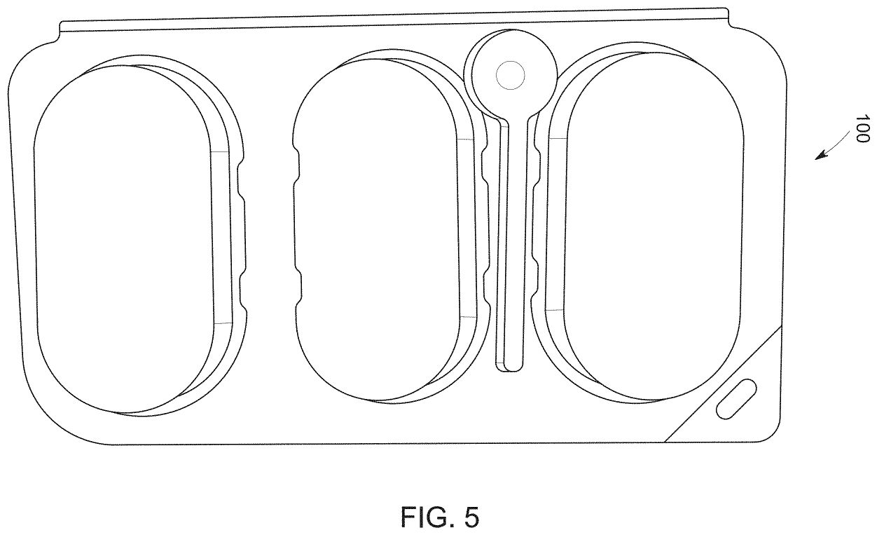

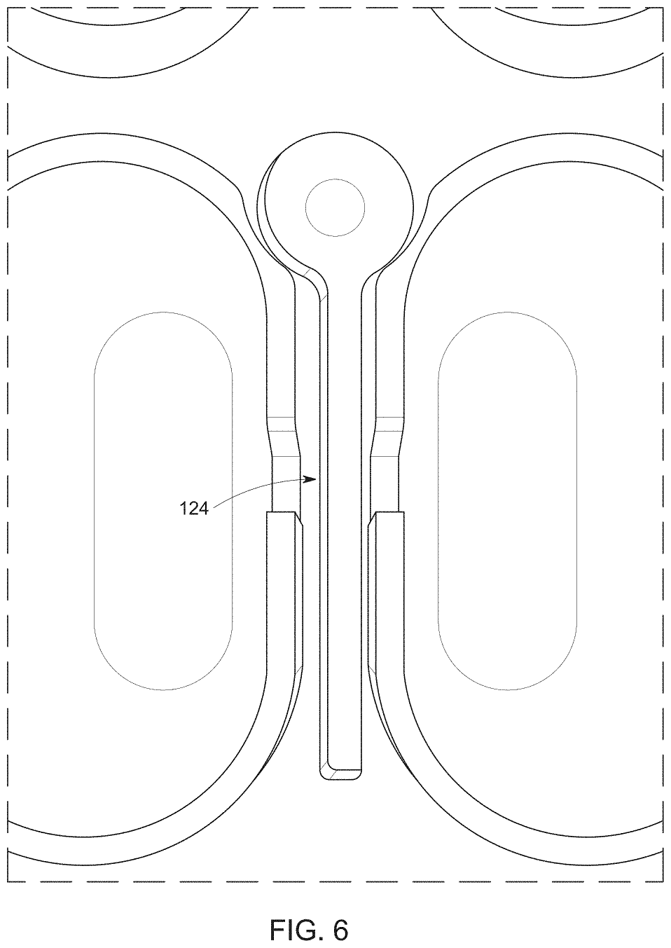

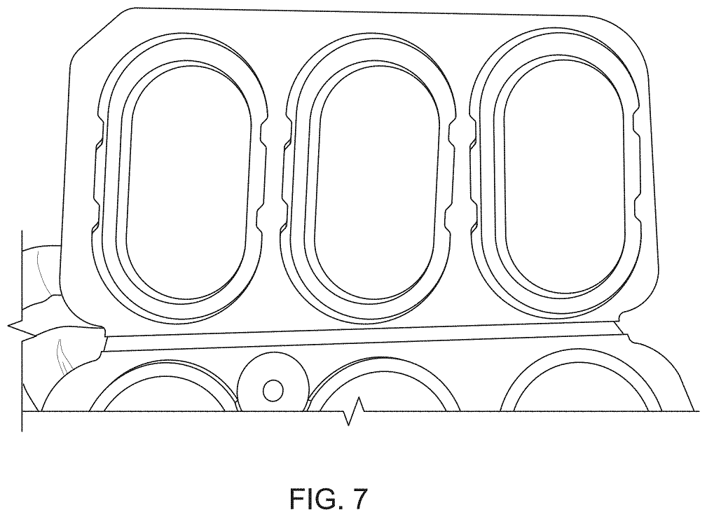

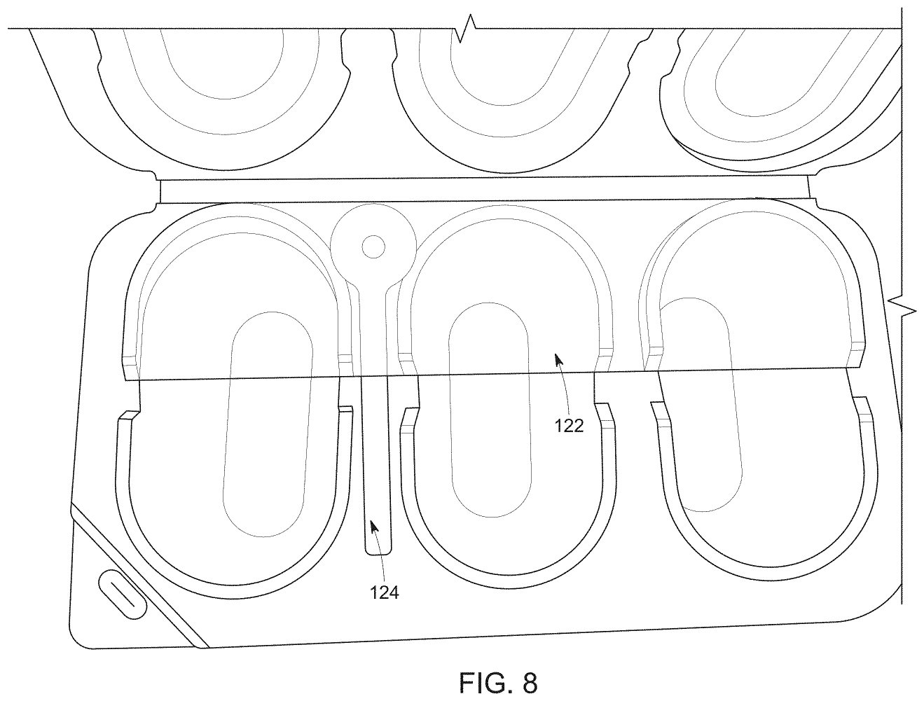

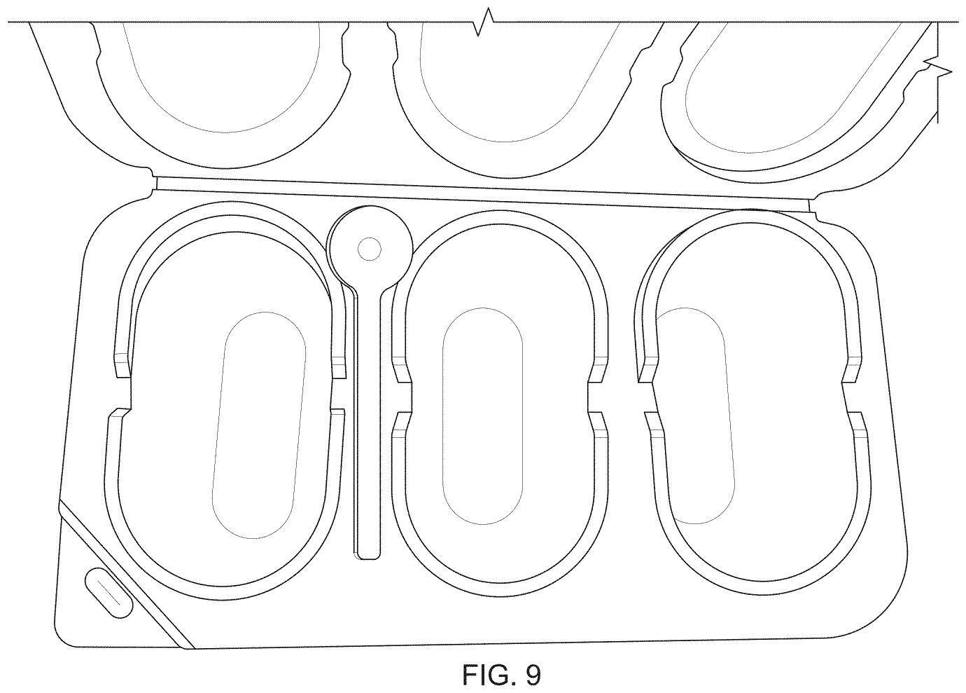

With reference to FIG. 2-FIG. 11, a description of a version of the invention will be provided and is generally designated as numeral 100. Generally, the compact ingredient container 100 comprises, a compartment body portion 104 for containing the baking ingredients and a lid portion 106 or one or more lids which are operably coupled with the compartment body portion 104 for containing and sealing the baking ingredients stored therein.

The compartment body 104 includes a plurality of separated compartments 108A, 108B, 108C, each compartment having a length, width and depth forming a volume of space 110 and terminating at an upper perimeter 112 which defines a top opening 113. Preferably, the volume of space 110 of each compartment is about or at least ½ cup or approximately 1,100 ml. In certain versions of the application, each compartment 108 may have an elevated lip 109 that extends at least partially about the upper perimeter defining the top opening.

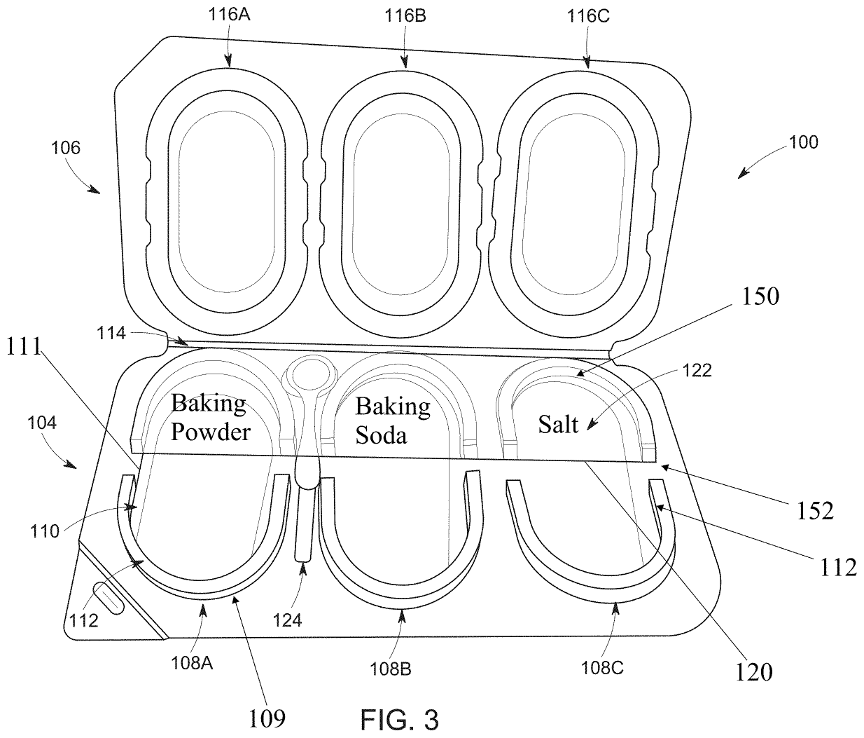

With reference to FIG. 3, the compact ingredient container 100 generally comprises one or more lids 116A-116C which are each configured to operably connect and close over each of the respective top openings 112 of the plurality of compartments 108A-108C, thereby forming a sealed volume of space 110 within each compartment 108A-108C for each independent baking ingredient contained therein.

In the illustrated version, the one or more lids 116 are integrally attached forming a unitary lid portion 106, the lid portion 106 is hingedly connected to the compartment body 104 permitting the container to move uniformly between a closed position and an open position.

Preferably, the one or more lids 116 are each formed as a cap imprint within the unitary lid portion 106. Each of the cap imprints 117 are operably dimensioned to fit over, mate, and seal with the respective adjacent compartment 108A-108C and compartment elevated lip 109, thereby forming together a sealed volume of space 110 therein for independent containment of each baking ingredient while the container is in the closed position.

As best shown in FIG. 2, in certain versions of the application, the container 100 may further comprise one or more leveling shelves 118, each having a forward leveling edge 120. In a version, the one or more leveling shelves 118 are operably positioned atop and extend laterally across each of the respective compartment 108 top openings 112, thereby allowing a user to dispense and level off a measuring spoon containing a portion of the selected baking ingredient.

In the illustrated version, each of the leveling shelves 118 are operably dimensioned to partially fit over and mate with the respective elevated lip 109 of each separate compartment 108. Further, each of the leveling shelves 118 are operably positioned atop and extend partially forward from a rear point 150 to an approximate midpoint 152 of the top opening 112 of each of the compartment 108A-108C, terminating at the forward leveling edge 120. Thereby, allowing the user to precisely dispense and level off the measuring spoon 102 containing a portion of a selected baking ingredient. In other terms, after filling the measuring spoon 102, the baker simply scrapes the spoon 102 against the shelf 118 forward leveling edge 120 to level it. Preferably, the one or more leveling shelves 118 are attachably removable from the compact ingredient container 100 and can be selectively utilized.

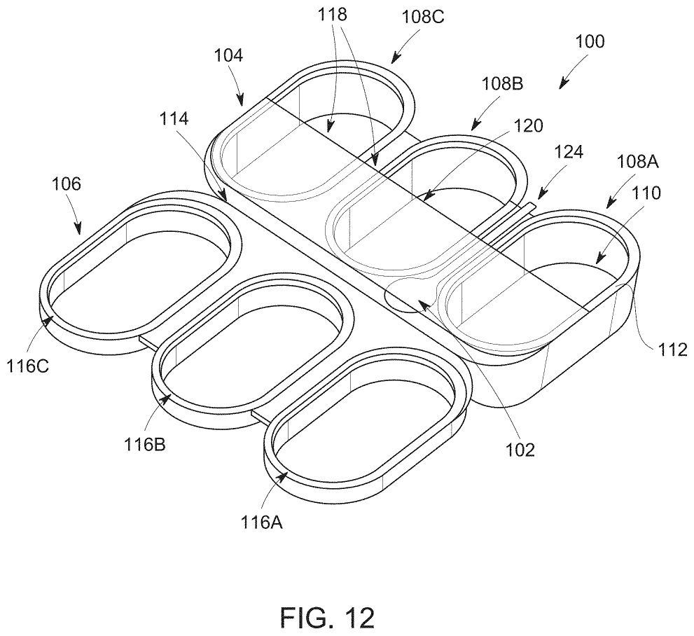

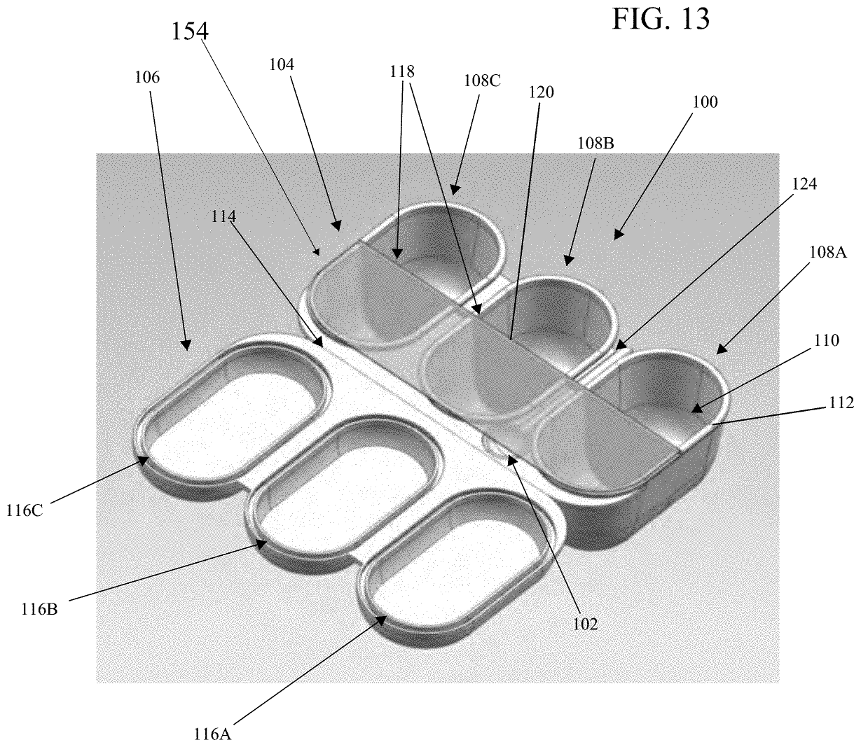

As shown in the figures, the one or more leveling shelves 118 may be integrally attached forming a unitary leveling shelf portion 154. The unitary leveling shelf portion 154 operably seats atop the compartment body 104 and may be removable (See FIG. 12).

In the illustrated version, the unitary leveling shelf portion 154 comprised of the one or more leveling shelves 118 is constructed of a clear unitary and continuous horizontal body configured to seat and fit between the hinged lid portion 106 and partially mate with the upper perimeter 112, elevated lip 109 of each of the compartments 108A-108C of the compartment body portion 104. The transparent quality of the material allows the baker to view the volume of space 110 in order to ascertain the quantity of baking ingredients in each compartment 108A-108C. Further, it is desirable that the leveling shelves 118 is/are removable from the container 100 for cleaning purposes. FIG. 9 illustrates the compact ingredient container 100 without the unitary leveling shelf portion 154. Moreover, baking ingredient labels 122 may be displayed on the top side of each leveling shelf 118 in order to identify the ingredients contained within each respective compartment 108.

In addition, the product may optionally include a plastic quarter-teaspoon measuring spoon 102, for incidental bakers who may not have a full kitchen available with traditional measuring spoons. In the version, the container 100 is further configured to provide a slot 124 configured and shaped to receive and store the measuring spoon 102 while not in use. Because recipes usually call for these ingredients in increments between ¼ teaspoon and 1 teaspoon, the spoon 102 provides a means of measuring commonly-used quantities for cooks without traditional measuring spoons at hand.

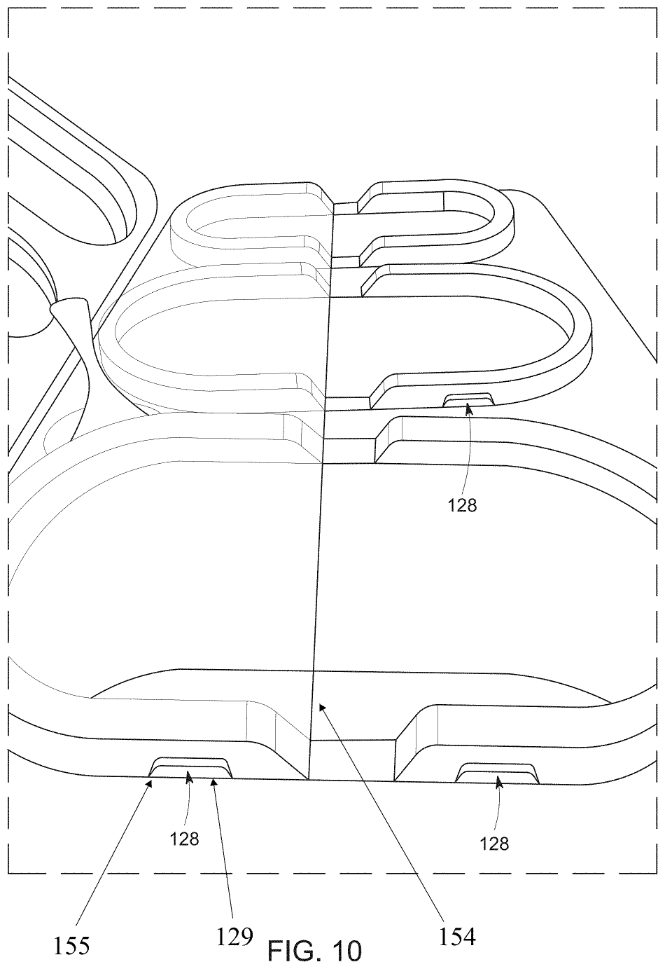

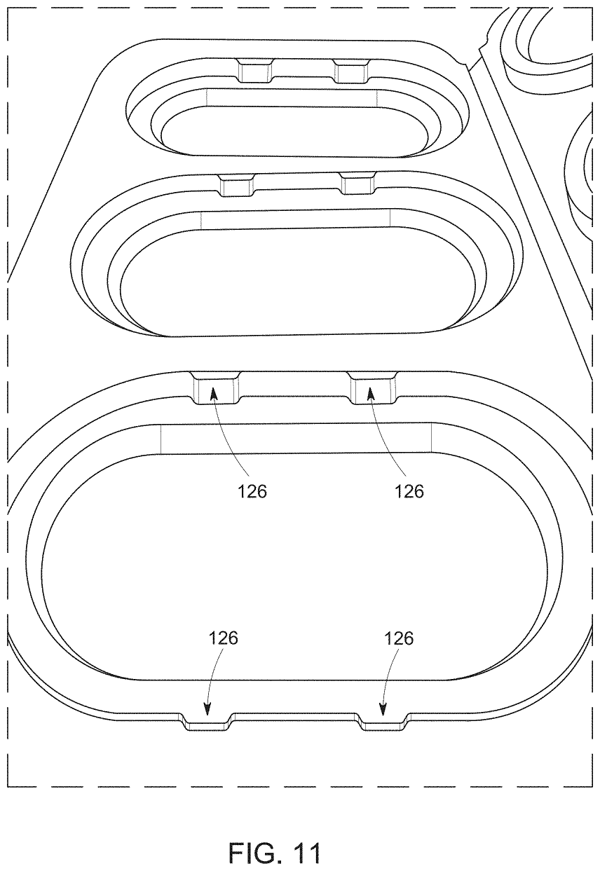

With reference to FIG. 10 and FIG. 11, a version of the application may further include one or more paired tabs 126 and indents 128 for providing a friction type snap fit between the compartment body portion 104 and the hinged lid portion 106. In the version, the lid portion 106 cap imprints 116 further include inward projecting tabs 126 which are designed to mate with respective indents 128 positioned on the exterior of each of the upper perimeters 112, elevated lips 109 of the compartment body 104 while in the closed position.

Similarly, each of the one or more leveling shelves 118 may comprise one or more inwardly projecting tabs 129 and wherein each of the compartment 108 elevated lips 109 comprise one or more reciprocal indents 128, wherein while the one or more leveling shelves 118 are fitted over the respective elevated lips 109, the respective tabs 129 mate with the respective indents 128, thereby providing a friction type fit between the leveling shelf 118 and the respective compartment 108 top opening 112.

Thus, preferably, during storage and while the container 100 is closed, the removable unitary leveling shelf portion 154 is nested between the compartment body 104 and the unitary lid portion 106. Some of the tabs 126 of the lid portion 106 may be configured to mate with the indents 155 embedded within the exterior surface of the one or more leveling shelves 118 (See FIG. 10).

In other embodiments of this invention, the container could be modified to similarly package and dispense other ingredients commonly used together in cooking or baking, in three or more compartments. Further, the compartments could be designed in larger or smaller quantities to accommodate various baking applications.

In the currently presented application, the compact ingredient container 100 measures approximately 18 cm. long, and 11 cm. wide, with a depth of 6 cm. Other dimensions can certainly be envisioned for different applications.

The compact ingredient container 100 can be made in any manner and of any material chosen with sound engineering judgment. Preferably, materials will be strong, lightweight, long lasting, economic, ergonomic, eco-friendly, and suitable for the storage of food products. The compact ingredient container 100 is preferably composed of a food-grade plastic. The current embodiment uses a vacuum forming process to manufacture the container, on a mold that has been created using Fused Deposition Modeling (FDM) 3D Printing.

The invention does not require that all the advantageous features and all the advantages need to be incorporated into every version of the invention.

Although preferred embodiments of the invention have been described in considerable detail, other versions and embodiments of the invention are certainly possible. Therefore, the present invention should not be limited to the described embodiments herein.

All features disclosed in this specification including any claims, abstract, and drawings may be replaced by alternative features serving the same, equivalent, or similar purpose unless expressly stated otherwise.

What is claimed:

1. A container for separately storing small quantities of baking ingredients, the container comprising:
a compartment body comprising a plurality of separate compartments, each separate compartment providing a depth and a volume of space, and terminating at an upper perimeter defining a top opening;
one or more lids configured to operably connect and close over each of the respective top openings of the plurality of compartments, thereby forming a sealed volume of space within each compartment for each independent baking ingredient contained therein; and
one or more leveling shelves having a forward leveling edge, each leveling shelf is operably positioned atop and extending laterally across each of the respective compartment top openings, thereby allowing a user to dispense and level off a measuring spoon containing a portion of the selected baking ingredient.

2. The container of claim 1, wherein the one or more lids are integrally attached forming a unitary lid portion, the lid portion is hingedly connected to the compartment body portion permitting the container to move uniformly between a closed position and an open position.

3. The container of claim 2, wherein each of the upper perimeters of the compartments form an elevated lip.

4. The container of claim 3, wherein each of the one or more lids is formed as a cap imprint within the unitary lid portion, each cap imprint is operably dimensioned to fit over and mate with the respective elevated lip of each separate compartment.

5. The container of claim 3, wherein the one or more leveling shelves are operably dimensioned to partially fit over and mate with the respective elevated lip of each separate compartment.

6. The container of claim 5, wherein the one or more leveling shelves are integrally attached forming a unitary leveling shelf portion, the leveling shelf portion operably seats atop the compartment body.

7. The container of claim 3, wherein each of the one or more leveling shelves comprise one or more inwardly projecting tabs and wherein each of the compartment elevated lips comprise one or more reciprocal indents, wherein while the one or more leveling shelves are fitted over the respective elevated lips, the respective tabs mate with the respective indents, thereby providing a friction type fit between the leveling shelf and the respective compartment top opening.

8. The container of claim 3, wherein each of the cap imprints comprise one or more inwardly projecting tabs and wherein each of the compartment upper lips comprise one or more respective indents, wherein while in the closed position, the tabs mate with the respective indents, thereby providing a friction type fit between the lid portion and the compartment body.

9. The container of claim 1, further comprising a measuring spoon for dispensing quantities of the baking ingredients, the container further comprising a slot configured and shaped to receive and store the measuring spoon while not in use.

10. A container for separately storing small quantities of baking ingredients, the container comprising:
a compartment body comprising a plurality of separate compartments, each separate compartment providing a depth and a volume of space for the receipt of baking ingredients, and terminating at an upper perimeter forming an elevated lip and a top opening;
one or more lids configured to operably connect and close over each of the respective top openings of the plurality of separate compartments, each of the lids comprise a cap imprint which is operably dimensioned to fit over and mate with the respective elevated lip of each separate compartment, thereby forming a sealed volume of space within each compartment for each independent baking ingredient contained therein; and
one or more leveling shelves having a forward leveling edge operably positioned atop and extending laterally across each of the separate compartment top openings, thereby allowing a user to dispense and level off a measuring spoon containing a portion of the selected baking ingredient.

11. The container of claim 1, further comprising a measuring spoon for dispensing quantities of the baking ingredients, the container further comprising a slot configured and shaped to receive and store the measuring spoon while not in use.

12. A container for separately storing small quantities of baking ingredients, the container comprising:
a compartment body having a front perimeter, rear perimeter, first side perimeter, and a second side perimeter, the compartment body comprising a plurality of aligned separated compartments, each compartment dimensioned to provide a depth and a volume of space for the receipt of baking ingredients, and terminating at an upper perimeter forming an elevated lip and a top opening;
a lid portion hingedly connected to the rear perimeter of the compartment body portion permitting the container to move between a closed position to an open position, the lid portion is configured to operably connect and close over each of the respective top openings of the plurality of separate compartments, wherein the lid portion comprises a plurality of cap imprints which are operably dimensioned to fit over and mate with the respective elevated lip of each separate compartment, thereby forming a sealed volume of space within each separate compartment for the respective independent baking ingredient contained therein; and
one or more leveling shelves having a forward leveling edge, each leveling shelf operably positioned atop and extending from a rear point to an approximate midpoint of the top opening terminating at the forward leveling edge, thereby allowing a user to dispense and level off a measuring spoon containing a portion of the selected baking ingredient.

13. The container of claim 1, further comprising a measuring spoon for dispensing quantities of the baking ingredients, the container further comprising a slot configured and shaped to receive and store the measuring spoon while not in use.
